(19) United States
(12) Patent Application Publication
(10) Pub. No.: US 2025/0373766 A1
(43) Pub. Date: Dec. 4, 2025

(54) CORRECTION METHOD AND PROJECTOR

(71) Applicant: SEIKO EPSON CORPORATION, Tokyo (JP)

(72) Inventor: Yutaro IIJIMA, Matsumoto-shi (JP)

(73) Assignee: SEIKO EPSON CORPORATION, Tokyo (JP)

(21) Appl. No.: 19/222,021

(22) Filed: May 29, 2025

(30) Foreign Application Priority Data
May 30, 2024 (JP) 2024-087948

(51) Int. Cl. H04N 9/31

(52) U.S. Cl. CPC H04N 9/3185; H04N 9/3194

(57) ABSTRACT

A method for correcting a projection image projected from a projector onto a projection surface, the method including: acquiring depth information indicating multiple distances from a distance sensor to multiple positions on the projection surface based on an output from the distance sensor, the distance sensor configured to irradiate the projection surface with radiated light and receive reflected light reflected off the projection surface; acquiring intensity information indicating an intensity of the reflected light at each of the multiple positions; generating a parameter that defines the projection surface based on the depth information and the intensity information; and correcting the projection image based on the parameter.

The present application is based on, and claims priority from JP Application Serial Number 2024-087948, filed May 30, 2024, the disclosure of which is hereby incorporated by reference herein in its entirety.

### BACKGROUND

### 1. Technical Field

The present disclosure relates to a correction method and a projector.

### 2. Related Art

There has been a related-art technology for determining the normal vector for a projection surface by using a value measured by a distance sensor provided in a projector, and correcting a projection image by using the determined normal vector.

For example, according to WO 2022/193560 acquires multiple pieces of depth information at multiple light spots on a projection surface by using a time-of-flight (ToF) sensor, and determines the normal vector for the projection surface based on the multiple depth information. Furthermore, the projector acquires offset information on the amount of offset of the projector based on the normal vector, and corrects a projection image based on the offset information.

WO 2022/193560 is an example of the related art.

In the technology according to WO 2022/193560, however, the accuracy of the multiple pieces of depth information at the multiple light spots decreases in some cases depending on the inclination and shape of the projection surface. When the scale of the original image is corrected based on the depth information with reduced accuracy, the result of the correction also deteriorates.

### SUMMARY

A correction method according to an aspect of the present disclosure is a method for correcting a projection image projected from a projector onto a projection surface, the method including: acquiring depth information indicating multiple distances from a distance sensor to multiple positions on the projection surface based on an output from the distance sensor, the distance sensor configured to irradiate the projection surface with radiated light and receive reflected light reflected off the projection surface; acquiring intensity information indicating an intensity of the reflected light at each of the multiple positions; generating a parameter that defines the projection surface based on the depth information and the intensity information; and correcting the projection image based on the parameter.

A projector according to another aspect of the present disclosure includes one or more processors configured to acquire depth information indicating multiple distances from a distance sensor to multiple positions on a projection surface based on an output from the distance sensor, the distance sensor configured to irradiate the projection surface with radiated light and receive reflected light reflected off the projection surface; acquire intensity information indicating an intensity of the reflected light at each of the multiple positions; generate a parameter that defines the projection surface based on the depth information and the intensity information; and correct a projection image based on the parameter.

### BRIEF DESCRIPTION OF THE DRAWINGS

FIG. 1 is a block diagram showing an example of the configuration of a projector.

FIG. 2 shows an example of depth information acquired by an acquisition section.

FIG. 3 illustrates a correspondence between the depth information and intensity information acquired by the acquisition section.

FIG. 4 illustrates the correspondence between the depth information and the intensity information acquired by the acquisition section.

FIG. 5 shows the depth information at a pixel in multiple frames.

FIG. 6 shows the depth information at the pixel and pixels adjacent to the pixel in a first frame.

FIG. 7 is a flowchart showing the operation of the projector.

### DESCRIPTION OF EMBODIMENTS

An embodiment for implementing the present disclosure will be described below with reference to the drawings. Note, however, that dimensions and scales of portions in the drawings are made different from actual ones as appropriate. Furthermore, the embodiment described below is a preferable specific example of the present disclosure, and various technically preferable restrictions are therefore imposed on the embodiment, but the scope of the present disclosure is not limited to the embodiment unless there is a description that the present disclosure is particularly limited to the embodiment in the following description.

### 1: First Embodiment

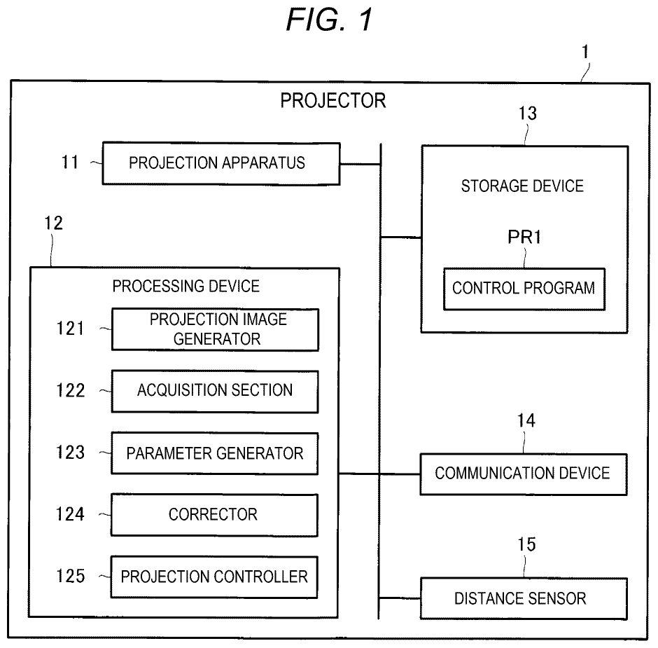

A projector 1 and a correction method according to a first embodiment will be described below with reference to FIGS. 1 to 7.

### 1-1: Configuration of First Embodiment

FIG. 1 is a block diagram showing an example of the configuration of the projector 1 according to the first embodiment. The projector 1 includes a projection apparatus 11, a processing device 12, a storage device 13, a communication device 14, and a distance sensor 15. The elements of the projector 1 are connected to each other via a single bus or multiple buses for information communication. The elements of the projector 1 each include a single or multiple instruments. Some of the elements of the projector 1 may be omitted.

The projection apparatus 11 is an apparatus that projects a projection image P_{I} generated by a projection image generator 121, which will be described later, on a screen S_{C}, a wall, or any other surface. The projection apparatus 11 projects various images under the control of the processing device 12. The projection apparatus 11 includes, for example, a light source, a liquid crystal panel, and a projection lens, modulates light from the light source through the liquid crystal panel, and projects the modulated light onto the screen S_{C}, the wall, or any other surface via the projection lens. The aspect in which the projection apparatus 11 includes a liquid crystal panel is merely an example, and aspects according to the present embodiment are not limited thereto. For example, the present embodiment is also applicable to a digital light processing (DLP: registered trademark) configuration including a digital mirror device (DMD) in place of a liquid crystal panel.

The processing device 12 is a processor that controls the entire projector 1, and is configured, for example, with a single chip or multiple chips. The processing device 12 is configured, for example, with a central processing unit (CPU) including an interface with a peripheral apparatus, an arithmetic device, a register, and so on. Note that some or all of the functions of the processing device 12 may be realized by hardware such as a digital signal processor (DSP), an application specific integrated circuit (ASIC), a programmable logic device (PLD), or a field programmable gate array (FPGA). The processing device 12 performs various types of processing in parallel or in sequence.

The storage device 13 is a recording medium readable by the processing device 12, and stores multiple programs including a control program PRI to be executed by the processing device 12. The storage device 13 may be configured, for example, with at least one of a read-only memory (ROM), an erasable programmable ROM (EPROM), an electrically erasable programmable ROM (EEPROM), and a random access memory (RAM). The storage device 13 may be called a register, a cache, a main memory, a main storage device, or the like.

The communication device 14 is hardware serving as a transmission and reception device for communicating with other apparatuses. Particularly in the present embodiment, the communication device 14 is a communication device that connects the projector 1 to the other apparatuses in a wired or wireless manner. The communication device 14 is also called, for example, a network device, a network controller, a network card, or a communication module.

The distance sensor 15 measures the distance between the distance sensor 15 and an object located around the projector 1. In the present embodiment, the distance sensor 15 irradiates a projection surface P_{P} of the screen S_{C} with radiated light and receives reflected light reflected off the projection surface P_{P}. The distance sensor 15 measures the distance between the distance sensor 15 and multiple points on the projection surface P_{P} based on the result of the detection of the reflected light. The distance sensor 15 is preferably a ToF sensor. The distance sensor 15 may instead, for example, be a light detection and ranging (LIDAR) device. The distance sensor 15 in the present embodiment has pixels the number of which is 6 px in each of an X-axis direction and a Y-axis direction. The number of pixels (resolution) of the distance sensor 15 in the present embodiment is therefore 6 px×6 px.

The processing device 12 functions as a projection image generator 121, an acquisition section 122, a parameter generator 123, a corrector 124, and a projection controller 125 by reading the control program PR1 from the storage device 13 and executing the control program PR1. Note that the control program PR1 may be transmitted via a communication network that is not shown from another apparatus such as a server that manages the projector 1.

The projection image generator 121 generates the projection image P_{I} based on an input image acquired by the projection image generator 121. Note that the projection image generator 121 may acquire an input image from an apparatus external to the projector 1 or may acquire an input image stored in the storage device 13.

The acquisition section 122 acquires depth information D_{I}, which indicates multiple distances from the distance sensor 15 to multiple positions on the projection surface P_{P}, and intensity information S_{I}, which indicates the intensity of the reflected light at each of the multiple positions, based on the output from the distance sensor 15.

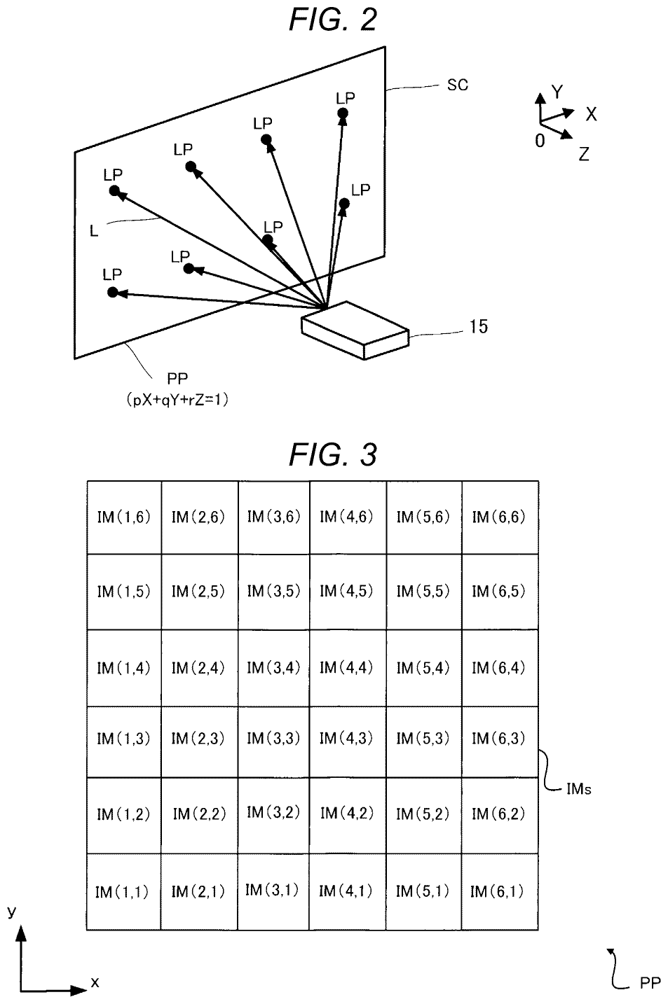

FIG. 2 shows an example of the depth information D_{I} acquired by the acquisition section 122. It is assumed that the projector 1 and the projection surface P_{P} are set in an XYZ coordinate system, which is a world coordinate system, as shown in FIG. 2. It is further assumed that the optical axis of the projector 1 is substantially parallel to the Z-axis. The optical axis of the projector 1 is, for example, the optical axis of the projection lens. Note that the term “substantially parallel” means being parallel with an error within an allowable range. As an example, when the distance sensor 15 is a ToF sensor, the distance sensor 15 irradiates multiple positions on the projection surface P_{P} with multiple laser beams L. The multiple laser beams L radiated onto the projection surface P_{P} form multiple light spots L_{P} on the projection surface P_{P}. The distance sensor 15 outputs the depth information D_{I} indicating multiple distances from the distance sensor 15 to the multiple light spots L_{P} based on a period from the time at which the distance sensor 15 radiates the multiple laser beams L to the time at which light receiving sensors provided in the distance sensor 15 detect reflected light from the multiple light spots L_{P} formed by the multiple laser beams L on the projection surface P_{P}. The acquisition section 122 acquires the depth information D_{I} output from the ToF sensor as the distance sensor 15. FIG. 2 shows a case where the light spots L_{P} are formed at eight positions out of 36 positions on the projection surface P_{P} that are the maximum number of positions detectable by the distance sensor 15.

Note that when the distance sensor 15 is a ToF sensor, the distance sensor 15 may irradiate the projection surface P_{P} with light from a surface emitting laser instead of irradiating the projection surface P_{P} with the multiple laser beams L as described above. In this case, the multiple light receiving sensors discretely incorporated in the distance sensor 15 detect the reflected light from the projection surface P_{P}.

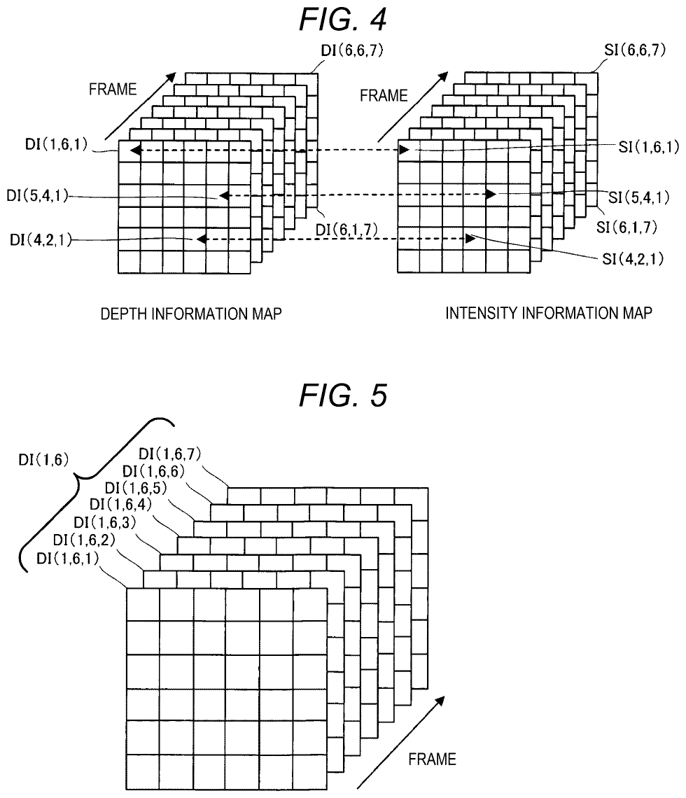

FIGS. 3 and 4 illustrate a correspondence between the depth information D_{I} and the intensity information S_{I} acquired by the acquisition section 122.

The distance sensor 15 measures the distances between the distance sensor 15 and the multiple points on the projection surface P_{P} based on the result of the detection of the reflected light, as described above.

It is now assumed that the projection surface P_{P} spreads in an xy plane by way of example, as shown in FIG. 3. It is further assumed that the projection surface P_{P} includes a pixel group IMs, and that the pixel group IMs is configured with multiple pixels I_{M}(1, 1) to I_{M}(6, 6). In FIG. 3, the pixels I_{M}(1, 1) to I_{M}(6, 1) are arranged in this order in an x-axis direction. The pixel I_{M}(1, 1) is shifted toward the −x side from the pixel I_{M}(6, 1). The pixels I_{M}(1, 1) to I_{M}(1, 6) are arranged in this order in a y-axis direction. The pixel I_{M}(1, 1) is shifted toward the −y side from the pixel I_{M}(1, 6).

The acquisition section 122 acquires the depth information D_{I} indicating the distance between the distance sensor 15 and the center point of each of the pixels I_{M}(1, 1) to I_{M}(6, 6) at each of multiple points of time. Assuming that n is a natural number, the acquisition section 122 acquires the depth information D_{I} in an n-th frame at the point of time of t=tₙ. The depth information D_{I} in the n-th frame is configured with depth information DI(1, 1, n) to depth information DI(6, 6, n) indicating the distances between the distance sensor 15 and the center points of the pixels I_{M}(1, 1) to I_{M}(6, 6).

The acquisition section 122 further acquires the intensity information S_{I} indicating the intensity of the reflected light reflected at each of the pixels I_{M}(1, 1) to I_{M}(6, 6) at each of the multiple points of time. Assuming that n is a natural number, the acquisition section 122 acquires the intensity information S_{I} in the n-th frame at the point of time of t=tₙ. The intensity information S_{I} in the n-th frame is configured with intensity information SI(1, 1, n) to intensity information SI(6, 6, n) indicating the intensities of the reflected light reflected at the pixels I_{M}(1, 1) to I_{M}(6, 6).

The intensity information S_{I} may be information on the intensity indicated by an output voltage output from the light receiving sensor corresponding to each of the pixels I_{M}(1,1) to I_{M}(6, 6). Instead, when the distance sensor 15 is a ToF sensor and the distance sensor 15 generates an I_{R} image by capturing an image of the projection surface P_{P} with infrared light, the intensity information S_{I} may be information on the intensity indicated by the magnitude of the signal output from the light receiving sensor described above based on the IR image. Still instead, when the light receiving sensor calculates pseudo reflectance substantially indicating the ratio of the amount of the reflected light received by the light receiving sensor to the amount of the projected light, the intensity information S_{I} may, for example, be information on the intensity indicated by the pseudo reflectance.

The acquisition section 122 acquires the depth information DI(1, 1, n) and the intensity information SI(1, 1, n) at the pixel I_{M}(1, 1) in association with each other at the point of time of t=tₙ. The same applies to the other pixels IM. The same applies also to the points of time other than t=tₙ. In FIG. 4, the acquisition section 122 acquires, for example, the depth information DI(1, 6, 1) and the intensity information SI(1, 6, 1) in association with each other. The acquisition section 122 further acquires, for example, the depth information DI(4, 2, 1) and the intensity information SI(4, 2, 1) in association with each other. The acquisition section 122 further acquires, for example, the depth information DI(5, 4, 1) and the intensity information SI(5, 4, 1) in association with each other.

In FIG. 1, the parameter generator 123 generates parameters that define the projection surface P_{P} based on the depth information D_{I} and the intensity information S_{I} acquired by the acquisition section 122.

More specifically, the parameter generator 123 may generate the parameters described above by using the intensities indicated by the intensity information S_{I} as weights to calculate a weighted average of the distances indicated by the depth information D_{I}. The parameter generator 123 may instead remove outliers from the distances indicated by the depth information D_{I} based on the result of comparison between the intensities indicated by the intensity information S_{I} and a threshold, and generate the parameters described above based on the distances indicated by the depth information D_{I} from which the outliers have been removed. The parameter generator 123 may still instead generate the parameters described above by using a weighted least squares method for producing coordinates calculated by using the distances indicated by the depth information D_{I}, and the intensities indicated by the intensity information S_{I} as the weights.

Note that the “parameters that define the projection surface PP” may, for example, be a normal vector for the projection surface P_{P} or coefficients of the equation of a plane that defines the position of the projection surface P_{P} in the XYZ coordinates.

### A: A Case Where the Weighted Average is Calculated

The parameter generator 123 may generate the parameters that define the projection surface P_{P} based on a weighted average of the distances indicated by multiple pieces of depth information D_{I} at the multiple points of time, the weighted average produced by using as the weights the intensities indicated by multiple pieces of intensity information S_{I} corresponding to the multiple pieces of depth information D_{I}.

FIG. 5 shows the depth information D_{I} at the pixel I_{M}(1, 6) in multiple frames. As an example, let a distance dᵢ be the distance indicated by the depth information DI(1, 6, i) at the pixel I_{M}(1, 6), and a weight wᵢ be the intensity indicated by the intensity information SI(1, 6, i) corresponding to the depth information DI(1, 6, i), and the parameter generator 123 uses Expression 1 below to calculate a distance dff, which is a weighted average of the distances from the distance sensor 15 to the pixel I_{M}(1, 6) over frames. Note that i is an integer greater than or equal to one but smaller than or equal to seven.

$$\begin{matrix}Expression 1 & \\ dff = \frac{{\sum }_{i = 1}^{7} {w}_{i} {d}_{i}}{{\sum }_{i = 1}^{7} {w}_{i}} & 1\end{matrix}$$

In FIG. 5, the same applies to the pixels I_{M}(1, 1) to I_{M}(6, 6) other than the pixel I_{M}(1, 6). In the example shown in FIG. 5, seven frames from a first frame to a seventh frame are shown. However, even when the number of frames differs from that in FIG. 5, the same applies except that the number corresponding to the number of frames in Expression 1 is a different number.

The parameter generator 123 may generate the parameters that define the projection surface P_{P} based on a weighted average of the distances indicated by multiple pieces of depth information D_{I} at at least some of the multiple positions adjacent to each other out of the multiple positions on the projection surface P_{P}. Note that the weights in this case are the intensities indicated by the multiple pieces of intensity information S_{I} corresponding to the multiple pieces of the depth information D_{I}.

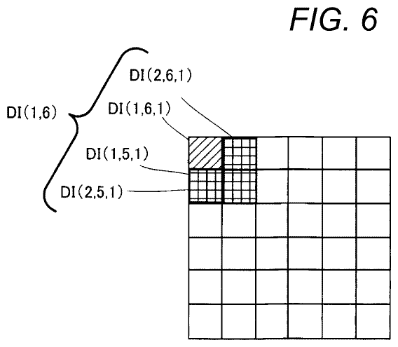

FIG. 6 shows the depth information D_{I} at the pixel I_{M}(1, 6) and the pixels I_{M}(1, 5), I_{M}(2, 5), and I_{M}(2, 6) adjacent to the pixel I_{M}(1, 6) in the first frame. Let a distance di be the distance indicated by the depth information DI(1, 6, 1) at the pixel I_{M}(1, 6), and a weight w₁ be the intensity indicated by the intensity information SI(1, 6, 1) corresponding to the depth information DI(1, 6, 1). Let a distance d₂ be the distance indicated by the depth information DI(1, 5, 1) at the pixel I_{M}(1, 5), and a weight w₂ be the intensity indicated by the intensity information SI(1, 5, 1) corresponding to the depth information DI(1, 5, 1). Let a distance d₃ be the distance indicated by the depth information DI(2, 5, 1) at the pixel I_{M}(2, 5), and a weight w₃ be the intensity indicated by the intensity information SI(2, 5, 1) corresponding to the depth information DI(2, 5, 1). Let a distance d₄ be the distance indicated by the depth information DI(2, 6, 1) at the pixel I_{M}(2, 6), and a weight w₄ be the intensity indicated by the intensity information SI(2, 6, 1) corresponding to the depth information DI(2, 6, 1). In this case, the parameter generator 123 may use the Expression 2 below to calculate a distance dmf, which is a weighted average of the distances to the pixel I_{M}(1, 6) that are averaged over the pixels adjacent thereto. Note that i is an integer greater than or equal to one but smaller than or equal to four.

$$\begin{matrix}Expression 2 & \\ dmf = \frac{{\sum }_{i = 1}^{4} {w}_{i} {d}_{i}}{{\sum }_{i = 1}^{4} {w}_{i}} & 2\end{matrix}$$

In FIG. 6, the same applies to the pixels I_{M}(1, 1) to I_{M}(6, 6) other than the pixel I_{M}(1, 6).

The parameter generator 123 may combine the method described with reference to FIG. 5 for calculating the distance dff, which is the weighted average over the frames, with the method described with reference to FIG. 6 for calculating the distance dmf, which is the weighted average over the adjacent pixels I_{M}.

Specifically, the parameter generator 123 may calculate the distance dff, which is the weighted average over the frames corresponding to the pixels I_{M}(1, 1) to I_{M}(6, 6), and then use the distance dff to calculate the distance dmf, which is the weighted average over the adjacent pixels I_{M}.

Instead, the parameter generator 123 may calculate the distance dmf, which is the weighted average over the pixels I_{M} adjacent to each of the pixels I_{M}(1, 1) to I_{M}(6, 6), and then use the distance dmf to calculate the distance dff, which is the weighted average over the frames corresponding to the pixels I_{M}(1,1) to I_{M}(6, 6).

### B: A Case Where Outliers Are Removed

The parameter generator 123 may compare the intensities indicated by multiple pieces of intensity information S with a threshold, extract intensity information St indicating intensities exceeding the threshold value, and generate the parameters that define the projection surface P_{P} based on the average of the distances indicated by multiple pieces of depth information D_{I} corresponding to the multiple pieces of intensity information S_{I}.

For example, when the intensities indicated by the intensity information SI(1, 6,2), the intensity information SI(1, 6, 3), and the intensity information SI(1, 6, 5) out of the intensities indicated by the multiple pieces of intensity information SI(1, 6, i) (i is an integer greater than or equal to one but smaller than or equal to seven) at the pixel I_{M}(1, 6) in multiple frames exceed the threshold, the parameter generator 123 sets the average of a distance d₂ indicated by the depth information DI(1, 6, 2), a distance d₃ indicated by the depth information DI(1, 6, 3), and a distance d₅ indicated by the depth information DI(1, 6, 5) in FIG. 5 as a distance dfs from the projection apparatus 11 to the pixel I_{M}(1, 6).

In FIG. 5, the same applies to the pixels I_{M}(1, 1) to I_{M}(6, 6) other than the pixel I_{M}(1, 6). In the example shown in FIG. 5, seven frames from a first frame to a seventh frame are shown. Note, however, that the same applies to a case where the number of frames differs from that in FIG. 5.

Instead, when the intensities indicated by the intensity information SI(1, 6, 1), the intensity information SI(1, 5, 1), and the intensity information SI(2, 6, 1) out of the multiple pieces of intensity information S_{I} at the pixel I_{M}(1, 6) and the pixel I_{M}(1, 5), the pixel I_{M}(2, 5), and the pixel I_{M}(2, 6) adjacent to the pixel I_{M}(1, 6) in the first frame exceed the threshold, the parameter generator 123 sets the average of the distance d₁ indicated by the depth information DI(1, 6, 1), the distance d₂ indicated by the depth information DI(1, 5, 1), and the distance d₄ indicated by the depth information DI(2, 6, 1) in FIG. 6 as a distance dms from the projection apparatus 11 to the pixel I_{M}(1, 6).

The parameter generator 123 may combine the method described with reference to FIG. 5 for calculating the distance dfs, which is the average over the frames, with the method described with reference to FIG. 6 for calculating the distance dms, which is the average over the adjacent pixels I_{M}.

Specifically, the parameter generator 123 may calculate the distance dfs, which is the average over the frames corresponding to the pixels I_{M}(1, 1) to I_{M}(6, 6), and then use the distance dfs to calculate the distance dms, which is the average over the adjacent pixels I_{M}.

Instead, the parameter generator 123 may calculate the distance dms, which is the average over the pixels I_{M} adjacent to each of the pixels I_{M}(1, 1) to I_{M}(6, 6), and then use the distance dms to calculate the distance dfs, which is the average over the frames corresponding to the pixels I_{M}(1, 1) to I_{M}(6, 6).

### C: A Case Where the Weighted Least Squares Method is Used

The parameter generator 123 calculates the coordinates of the center point of each of the pixel I_{M}(1, 1) to the pixel I_{M}(6, 6) in the XYZ coordinate system based on the distances from the projection apparatus 11 to the center point that are indicated by multiple pieces of depth information D_{I} at multiple points of time. Since the coordinates of the center point of each of the pixels I_{M}(1, 1) to I_{M}(6, 6) are calculated based on the multiple pieces of depth information D_{I} at the multiple points of time, there are as many coordinates as the number of frames. The parameter generator 123 may fit a plane to the point group of the center points of the pixels I_{M}(1, 1) to I_{M}(6, 6), the number of the center points being equal to the number of frames. The parameter generator 123 fits the plane by using the weighted least squares method using as the weights the multiple pieces of intensity information S_{I} at the multiple points of time.

For example, when the equation of the projection surface P_{P} is expressed by pX+qY+rZ=1 as shown in FIG. 2, and the coordinates of the point group of the center points are expressed by (X, Y, Z)=(Xₖ, Yₖ, Zₖ), where k is an integer from 1 to u, the parameter generator 123 generates p, q, and r that minimize mₙ expressed by Expression 3 below.

$$\begin{matrix}Expression 3 & \\ {m}_{n} = min {\sum }_{k = 1}^{u} \frac{{( 1 - {pX}_{k} - {qY}_{k} - {rZ}_{k} )}^{2}}{{{σ}_{k}}^{2}} & 3\end{matrix}$$

The parameter generator 123 uses each of the multiple pieces of intensity information S_{I} corresponding to the multiple pieces of depth information D_{I} at the multiple points of time as σk in Expression 3 described above. The multiple pieces of intensity information S_{I} each correspond to each of the coordinates (X, Y, Z)=(Xₖ, Yₖ, Zₖ) of the point group of the center points.

In FIG. 1, the corrector 124 corrects the projection image P_{I} generated by the projection image generator 121 by using the parameters generated by the parameter generator 123.

As an example, the corrector 124 uses the parameters described above to perform trapezoidal correction on the projection image P_{I} on the projection surface P_{P} so that the projection image P_{I} has a rectangular shape.

The projection controller 125 causes the projection apparatus 11 to project the projection image P_{I} corrected by the corrector 124 onto the projection surface P_{P}.

### 1-2: Operation in First Embodiment

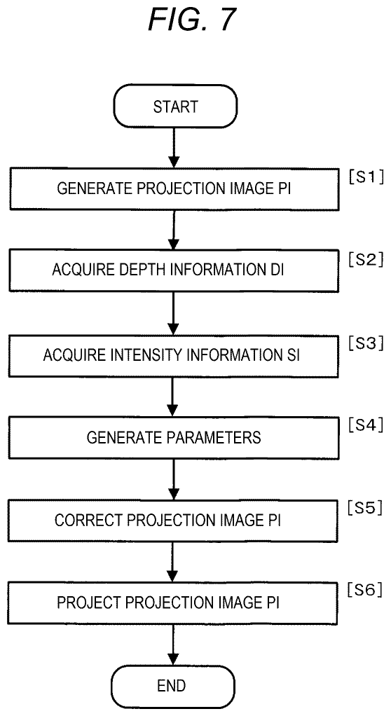

FIG. 7 is a flowchart showing the operation of the projector 1 according to the present embodiment.

In step S1, the processing device 12 functions as the projection image generator 121. The processing device 12 generates the projection image P_{I} based on an input image.

In step S2, the processing device 12 functions as the acquisition section 122. The processing device 12 acquires the depth information D_{I} indicating multiple distances from the distance sensor 15 to multiple positions on the projection surface P_{P} based on the output from the distance sensor 15.

In step S3, the processing device 12 functions as the acquisition section 122. The processing device 12 acquires the intensity information S_{I} indicating the intensities of the reflected light at the multiple positions on the projection surface P_{P} based on the output from the distance sensor 15.

In step S4, the processing device 12 functions as the parameter generator 123. The processing device 12 generates the parameters that define the projection surface P_{P} based on the depth information D_{I} acquired in step S2 and the intensity information S_{I} acquired in step S3.

In step S5, the processing device 12 functions as the corrector 124. The processing device 12 corrects the projection image P_{I} based on the parameters generated in step S4.

In step S6, the processing device 12 functions as the projection controller 125. The processing device 12 causes the projection apparatus 11 to project the projection image PI corrected in step S5 onto the projection surface P_{P}.

Note in step S4 of the flowchart in FIG. 7 that when the depth information D_{I} and the intensity information S_{I} sufficient for the processing device 12 to generate the parameters have not been successfully acquired, it is preferable that the processing device 12 repeats at least one of steps S2 and S3 until sufficient depth information D_{I} and intensity information S_{I} can be acquired.

### 2: Variations

The embodiment described above can be changed in various manners. Specific aspects of the variations will be presented below by way of example. The aspects presented below by way of example and the aspects shown in the embodiment described above can be combined with each other as appropriate to the extent that the aspects to be combined with each other do not contradict each other. Note that in the variations presented below by way of example, elements providing effects and having functions that are the same as those in the embodiment have the same reference characters referred to in the above description, and will not be described in detail as appropriate.

### 2-1: Variation 1

In the embodiment described above, for example, when the intensity information S_{I} is information on the intensity indicated by the magnitude of the signal output from each of the light receiving sensors, and when the magnitude of the signal is too strong, the signal is saturated, so that the accuracy of the distance indicated by the depth information D_{I} may decrease. Therefore, when the magnitude of the signal is too strong, it is preferable that the parameter generator 123 reduces the weight by which the distance indicated by the depth information D_{I} corresponding to the light receiving sensor is multiplied. It is instead preferable that the parameter generator 123 widens the range of the distances determined as outliers by increasing the threshold compared with the magnitude of the signal.

### 2-2: Variation 2

In the embodiment described above, the parameter generator 123 generates the parameters by using the intensities indicated by the intensity information S_{I} as weights to calculate a weighted average of the distances indicated by the depth information D_{I}. The parameter generator 123 instead removes outliers from the distances indicated by the depth information D_{I} based on the result of comparison between the intensities indicated by the intensity information S_{I} and a threshold, and generate the parameters based on the distances indicated by the depth information D_{I} from which the outliers have been removed. The parameter generator 123 still instead generates the parameters by using the weighted least squares method for producing coordinates calculated by using the distances indicated by the depth information D_{I}, and the intensities indicated by the intensity information S_{I} as the weights.

However, the parameter generator 123 does not necessarily generate the parameters as described above, and may generate the parameters by using any method using the intensities indicated by the intensity information S_{I} in addition to the distances indicated by the depth information D_{I}.

### 2-3: Variation 3

Depending on the material of the projection surface P_{P}, the parameter generator 123 cannot in some cases calculate the parameters with sufficient accuracy and correct the projection image P_{I}. In such a case, the projector 1 may attach a substance having high reflectance to the surface of the projection surface P_{P} and then perform the correction method shown in the embodiment described above.

### 3: Summary of Present Disclosure

The present disclosure will be summarized below as additional remarks.

Additional Remark 1 A method for correcting a projection image projected from a projector onto a projection surface, the method including: acquiring depth information indicating multiple distances from a distance sensor to multiple positions on the projection surface based on an output from the distance sensor, the distance sensor configured to irradiate the projection surface with radiated light and receive reflected light reflected off the projection surface; acquiring intensity information indicating an intensity of the reflected light at each of the multiple positions; generating a parameter that defines the projection surface based on the depth information and the intensity information; and correcting the projection image based on the parameter.

The correction method according to the present embodiment, which is configured as described above, improves the accuracy of the correction of the projection image P_{I}. Specifically, the correction method, which calculates the parameter by using the intensity information S_{I} in addition to the depth information D_{I}, improves the accuracy of the calculation of the parameter as compared with a case where the parameter is calculated by using only the depth information D_{I}. The accuracy of the correction of the projection image P_{I} is thus also improved.

In particular, when a ToF sensor is used as the distance sensor 15, and when the distance sensor 15 is separate from the projection surface P_{P} by a long distance, or when the distance sensor 15 inclines with respect to the projection surface P_{P} by a large angle, the accuracy of the measurement of the distance to the projection surface P_{P} decreases. The accuracy may also decrease depending on the material of an object with which the projection surface P_{P} is configured. Under the conditions that the accuracy decreases, variation of the measurement performed by the ToF sensor increases, but the average or the median of the measurement variation does not necessarily coincide with the true value. It is therefore difficult to estimate the distance to the projection surface P_{P} with high accuracy only by using the depth information D_{I} acquired from the ToF sensor.

When the accuracy of the measurement of the distance to the projection surface P_{P} performed by the ToF sensor decreases, appropriate reflected light does not return to the ToF sensor for any of the reasons described above. Therefore, when the measurement accuracy decreases, the magnitude of the signal indicating the light measured by the ToF sensor may decrease. Under the circumstances described above, the correction method according to the present embodiment can be expected to improve the measurement accuracy by using both the depth information D_{I} and the intensity information S_{I} to measure the 3D shape of the projection surface P_{P} with high accuracy.

In the trapezoidal correction performed by the projector, it is therefore necessary to acquire information on the planarity of the projection surface P_{P} with high accuracy. Measuring the projection surface P_{P} in the correction method according to the present embodiment allows the projector 1 to perform trapezoidal correction with high accuracy.

Additional Remark 2 The correction method according to Additional Remark 1, wherein generating the parameter that defines the projection surface based on the depth information and the intensity information includes comparing each intensity indicated by the intensity information with a threshold, and generating the parameter that defines the projection surface based on the depth information corresponding to the intensity information indicating the intensity that exceeds the threshold.

The correction method according to the present embodiment, which is configured as described above, improves the accuracy of the depth information D_{I}, and also consequently improves the accuracy of the correction of the projection image P_{I}.

In the related art, only the depth information D_{I} output from the ToF sensor is used, and an error is reduced, for example, by averaging, but only the depth information D_{I} does not allow identification of a distance that is an outlier, so that the error cannot be completely removed. The correction method according to the present embodiment, which uses the intensity information S_{I} in addition to the depth information D_{I} provided from the ToF sensor, can perform the 3D measurement of the projection surface P_{P} with high accuracy.

Additional Remark 3 The correction method according to Additional Remark 2, wherein the depth information and the intensity information are acquired at multiple points of time, and generating the parameter that defines the projection surface includes generating the parameter that defines the projection surface based on the depth information corresponding to the intensity information indicating the intensity that exceeds the threshold and acquired at one or more points of time.

The correction method according to the present embodiment, which is configured as described above, further improves the accuracy of the depth information D_{I}, and also consequently improves the accuracy of the correction of the projection image P_{I}.

Additional Remark 4 The correction method according to Additional Remark 1, wherein the parameter that defines the projection surface is generated at each of the multiple positions by using a weighted least squares method based on the depth information and the intensity information corresponding to each other and on each intensity indicated by the intensity information as a weight.

The correction method according to the present embodiment, which is configured as described above, improves the accuracy of the depth information D_{I}, and also consequently improves the accuracy of the correction of the projection image Pr.

Additional Remark 5 The correction method according to Additional Remark 1, wherein the depth information and the intensity information are acquired at multiple points of time, and the parameter that defines the projection surface is generated based on a weighted average of distances indicated by the multiple pieces of depth information at the multiple points of time, the weighted average produced by using as a weight each intensity indicated by the intensity information corresponding to each of the multiple pieces of depth information.

The correction method according to the present embodiment, which is configured as described above, further improves the accuracy of the depth information D_{I}, and also consequently improves the accuracy of the correction of the projection image P_{I}.

Additional Remark 6 The correction method according to Additional Remark 1, wherein the parameter that defines the projection surface is generated based on a weighted average of distances indicated by the depth information at at least multiple positions adjacent to each other out of the multiple positions, the weighted average produced by using as a weight each intensity indicated by the intensity information corresponding to the depth information.

The correction method according to the present embodiment, which is configured as described above, further improves the accuracy of the depth information D_{I}, and also consequently improves the accuracy of the correction of the projection image P_{I}.

Additional Remark 7 A projector including one or more processors configured to acquire depth information indicating multiple distances from a distance sensor to multiple positions on a projection surface based on an output from the distance sensor, the distance sensor configured to irradiate the projection surface with radiated light and receive reflected light reflected off the projection surface; acquire intensity information indicating an intensity of the reflected light at each of the multiple positions; generate a parameter that defines the projection surface based on the depth information and the intensity information; and correct a projection image based on the parameter.

The projector 1 according to the present embodiment, which is configured as described above, improves the accuracy of the correction of the projection image P_{I}. Specifically, the projector 1, which calculates the parameter by using the intensity information S_{I} in addition to the depth information D_{I}, improves the accuracy of the calculation of the parameter as compared with a case where the parameter is calculated by using only the depth information D_{I}. The accuracy of the correction of the projection image P_{I} is thus also improved.

In particular, when a ToF sensor is used as the distance sensor 15, and when the distance sensor 15 is separate from the projection surface P_{P} by a long distance, or when the distance sensor 15 inclines with respect to the projection surface P_{P} by a large angle, the accuracy of the measurement of the distance to the projection surface P_{P} decreases. The accuracy may also decrease depending on the material of an object with which the projection surface P_{P} is configured. Under the conditions that the accuracy decreases, variation of the measurement performed by the ToF sensor increases, but the average or the median of the measurement variation does not necessarily coincide with the true value. It is therefore difficult to estimate the distance to the projection surface P_{P} with high accuracy only by using the depth information D_{I} acquired from the ToF sensor.

When the accuracy of the measurement of the distance to the projection surface P_{P} performed by the ToF sensor decreases, appropriate reflected light does not return to the ToF sensor for any of the reasons described above. Therefore, when the measurement accuracy decreases, the magnitude of the signal indicating the light measured by the ToF sensor may decrease. Under the circumstances described above, the projector 1 according to the present embodiment can be expected to improve the measurement accuracy and measure the 3D shape of the projection surface P_{P} with high accuracy by using both the depth information D_{I} and the intensity information S_{I}.

In the trapezoidal correction performed by the projector, it is therefore necessary to acquire information on the planarity of the projection surface P_{P} with high accuracy. Measuring the projection surface P_{P}, onto which the projector 1 according to the present embodiment performs projection, allows the projector 1 to perform trapezoidal correction with high accuracy.

What is claimed is:

1. A method for correcting a projection image projected from a projector onto a projection surface, the method comprising:
acquiring depth information indicating multiple distances from a distance sensor to multiple positions on the projection surface based on an output from the distance sensor, the distance sensor configured to irradiate the projection surface with radiated light and receive reflected light reflected off the projection surface;
acquiring intensity information indicating an intensity of the reflected light at each of the multiple positions;
generating a parameter that defines the projection surface based on the depth information and the intensity information; and
correcting the projection image based on the parameter.

2. The correction method according to claim 1, wherein
generating the parameter that defines the projection surface based on the depth information and the intensity information includes
comparing each intensity indicated by the intensity information with a threshold, and
generating the parameter that defines the projection surface based on the depth information corresponding to the intensity information indicating the intensity that exceeds the threshold.

3. The correction method according to claim 2, wherein
the depth information and the intensity information are acquired at multiple points of time, and
generating the parameter that defines the projection surface includes generating the parameter that defines the projection surface on based the depth information corresponding to the intensity information indicating the intensity that exceeds the threshold and acquired at one or more points of time.

4. The correction method according to claim 1, wherein
the parameter that defines the projection surface is generated at each of the multiple positions by using a weighted least squares method based on the depth information and the intensity information corresponding to each other and on each intensity indicated by the intensity information as a weight.

5. The correction method according to claim 1, wherein
the depth information and the intensity information are acquired at multiple points of time, and
the parameter that defines the projection surface is generated based on a weighted average of distances indicated by the multiple pieces of depth information at the multiple points of time, the weighted average produced by using as a weight each intensity indicated by the intensity information corresponding to each of the multiple pieces of depth information.

6. The correction method according to claim 1, wherein
the parameter that defines the projection surface is generated based on a weighted average of distances indicated by the depth information at at least multiple positions adjacent to each other out of the multiple positions, the weighted average produced by using as a weight each intensity indicated by the intensity information corresponding to the depth information.

7. A projector comprising one or more processors configured to
acquire depth information indicating multiple distances from a distance sensor to multiple positions on a projection surface based on an output from the distance sensor, the distance sensor configured to irradiate the projection surface with radiated light and receive reflected light reflected off the projection surface;
acquire intensity information indicating an intensity of the reflected light at each of the multiple positions;
generate a parameter that defines the projection surface based on the depth information and the intensity information; and
correct a projection image based on the parameter.
